(19) United States
(12) Patent Application Publication
(10) Pub. No.: US 2013/0200291 A1
(43) Pub. Date: Aug. 8, 2013

(54) Tertiary Amine-Based Switchable Cationic Surfactants and Methods and Systems of Use Thereof

(71) Applicant: Queen's University, Kingston (CA)

(72) Inventors: Philip G. Jessop, Kingston (CA); Michael F. Cunningham, Kingston (CA)

(73) Assignee: Queen's University at Kingston, Kingston (CA)

(21) Appl. No.: 13/751,963

(22) Filed: Jan. 28, 2013

Related U.S. Application Data
(60) Provisional application No. 61/591,660, filed on Jan. 27, 2012.

(51) Int. Cl. B01F 17/00; B03D 1/018

(52) U.S. Cl. CPC B01F 17/0042; B03D 1/018
USPC 252/61; 422/129; 252/182.12; 564/271; 564/278; 564/296

(57) ABSTRACT

The present application provides switchable cationic surfactants based on tertiary amines, and methods and systems of use thereof. The tertiary amine structure allows these switchable surfactants to reversibly switch from a non-surfactant form to a surfactant form by simple introduction of an ionizing trigger gas that comprises CO₂, CS₂, COS, or a mixture thereof, at a pressure and an amount sufficient to convert all or a substantial portion of the amine to said salt, where the total pressure of the ionizing trigger gas is approximately ambient pressure. These tertiary amine-based switchable surfactants are further characterized by facile switching from the surfactant form to the non-surfactant form.

### FIELD OF THE INVENTION

The present application pertains to the field of cationic surfactants. More particularly, the present application relates to cationic surfactants and surfactant systems that are reversibly switchable between a non-surfactant and a surfactant form.

### INTRODUCTION

Surfactants are used in many processes to stabilize a dispersion of two immiscible phases, for example, as stable emulsions, suspensions or foams. Often, this stabilization is only required for one step of the process, such as in the cases of viscous oil pipelining, metal degreasing, oil sands separations and emulsion polymerization where the desired product is in the form of a polymer resin.¹ For example, a latex suspension of a polymer must be stable during the preparation of the polymer and during storage and shipping, but a stable suspension is not desired for the subsequent steps such as collection of the polymer by filtration or after the latex has been applied as paint on a surface. If the emulsion, suspension or foam is stabilized by a surfactant while stability is desired, then there is a significant advantage to being able to “switch off” the surfactant when the stability is no longer desired.

To address this issue, a class of surfactants termed “switchable surfactants” has been developed, whose surface activity can be reversibly altered by the application of a trigger. Switchability can be triggered by altering pH,^{2,3} adding redox reagents⁴⁻¹² or applying UV light.^{13,14} Surfactants containing ferrocenyl moieties^{4,5,7-10} and “pepfactants”^{15,16} (which are switchable surfactants based on a series of amino acids) are expensive, those containing viologen⁶ moieties are toxic, and all of the above rely on the addition of oxidants, reductants, acids or bases to trigger the switch. Photochemical azobenzene surfactants use only light as a trigger, but are limited to non-opaque samples. Switchable surfactants containing amidine¹⁷⁻¹⁹ or guanidine^{18,19} headgroups and long chain alkyl or ethoxylated^{20,21} tails have recently been developed. These surfactants are charged in the presence of CO₂ due to the formation of bicarbonate salts, and uncharged upon removal of CO₂ (Scheme 1). The basicity of the surfactant headgroup affects the reaction equilibrium and thus the ratio of charged to uncharged forms at a given temperature. Guanidines are generally the most basic and require the most forcing conditions (high temperatures, faster gas flow rates) to remove the CO₂, whereas CO₂ can be removed from less basic amines at more ambient conditions. This is evidenced by the lower conversions of tertiary amines versus guanidines to bicarbonate salts at a given temperature.¹⁸ The basicity of amidines generally lies between the above two cases.

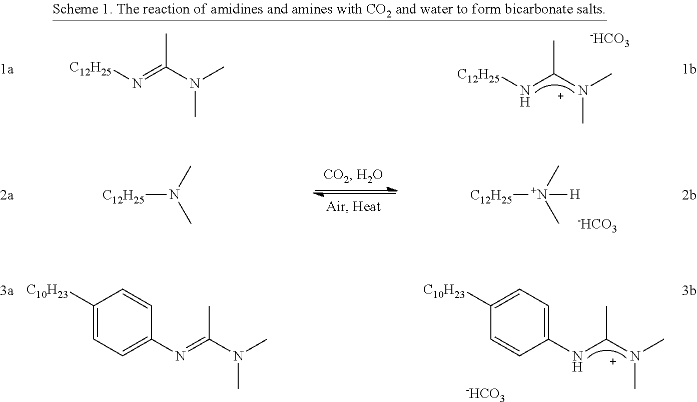

The long chain alkyl amidine bicarbonate 1b has been previously shown to be effective for stabilizing emulsions of styrene and methyl methacrylate (MMA) in water and polymer colloids resulting from the emulsion polymerization of those monomers.^{17,22,23} This is a highly valued chemical process used in the manufacture of synthetic rubbers, paints, adhesives, inks, and sealants, among a variety of other high quality materials.²²⁻²⁴ It offers the advantage of being much more rapid and controllable than its solvent based counterpart, and eliminates the use of potentially hazardous, volatile solvents during synthesis. The product of the emulsion polymerization process is a dispersion of polymer particles in water, but for many applications the dry, solid form of the polymer is desired. Destabilization of the dispersion is carried out industrially using salts, or strong acids or bases to alter the electronic environment surrounding the particles, allowing them to form larger particles, or flocs, that can be easily separated from water.²² In contrast, polymer latexes synthesized using 1b can be destabilized simply by removal of CO₂ using air or an inert gas and heat.^{17,22,23} While the environmental impact of using air is lower than that of using salt, strong acid or base, the destabilization times are on the order of hours, which is too slow for practical purposes.²²

U.S. Patent Publication No. 2008/197084 disclosed reversibly switchable surfactants that contain amidine and guanidine headgroups, as well as switchable surfactants that contain amine headgroups. The tertiary amine containing switchable surfactant compounds were identified as being less basic than the amidine and guanidine-containing switchable surfactant and, further, as requiring the application of high pressure CO₂ to switch from their “off” form to their “on” form.

The above information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide tertiary amine- based switchable cationic surfactants and methods and systems of use thereof. In accordance with an aspect of the present application, there is provided a composition comprising:

(a) water, an aqueous solution, an alcohol or a combination thereof;

(b) a switchable surfactant compound that is a tertiary amine salt comprising a hydrophobic portion, wherein said tertiary amine salt reversibly converts to a non-salt form following contact with a vacuum, heat and/or a flushing gas, wherein said flushing gas is a nonreactive gas that contains insufficient CO₂, CS₂, or COS to sustain the switchable surfactant compound in its salt form;

(c) a water immiscible liquid that is in a stable emulsion with said water or aqueous solution and forms an unstable emulsion or other two-phase mixture with said water or aqueous solution when the switchable surfactant compound is converted to the non-salt form, or a water insoluble solid that is in a stable suspension with said water or aqueous solution and forms an unstable suspension or other two-phase mixture with said water or aqueous solution when the switchable surfactant compound is converted to the non-salt form; and

(d) an ionizing trigger gas that comprises CO₂, CS₂, COS, or a mixture thereof, at a pressure and an amount sufficient to convert all or a substantial portion of the amine to said salt, wherein the total pressure of the ionizing trigger gas is approximately ambient pressure.

In accordance with another aspect of the application, there is provided a method for reversibly converting a tertiary amine compound of Formula I to a surfactant,

R¹R²NR³

where
at least one of R¹, R², and R³ is a hydrophobic moiety selected from the group consisting of higher aliphatic moiety, higher siloxyl moiety, higher aliphatic/siloxyl moiety, aliphatic/aryl moiety, siloxyl/aryl moiety, and aliphatic/siloxyl/aryl moiety; and
the rest of R¹, R², and R³ are selected from the group consisting of a substituted or unsubstituted C₁ to C₄ alkyl group, (SiO)₁ to (SiO)₂, and Cₙ(SiO)ₘ where n is a number from 0 to 4 and m is a number from 0 to 2 and n+m≦4;
where the higher aliphatic and/or siloxyl moiety is a hydrocarbon and/or siloxyl moiety having a chain length of linked atoms corresponding to that of C₈ to C₂₅, which may be substituted or unsubstituted, and may optionally contain one or more SiO unit, one or more aryl or heteroaryl groups, one or more ether linkages, one or more ester linkages or combinations of two or more of these, and wherein the hydrophobic moiety is not substituted with an aromatic group or an electronegative atom on the carbon alpha to the amine nitrogen or a fluorine atom on the carbon beta to the amine nitrogen and wherein an aryl or heteroaryl group is not directly attached to the amine nitrogen,

said method comprising the step treating the tertiary amine compound with an ionizing trigger gas that comprises CO₂, CS₂, COS, or a mixture thereof, at a pressure and an amount sufficient to convert all or a substantial portion of the amine to said salt, wherein the total pressure of the ionizing trigger gas is approximately ambient pressure.

In accordance with another aspect of the application, there is provided a switchable surfactant system comprising
(a) water or an aqueous solution;
(b) a switchable surfactant compound that is
   in its surfactant form, wherein the surfactant form is a tertiary amine salt comprising a hydrophobic portion, wherein said tertiary amine salt reversibly converts to a non-salt form following contact with a vacuum, heat and/or a flushing gas, wherein said flushing gas is a nonreactive gas that contains insufficient CO₂, CS₂, or COS to sustain the switchable surfactant compound in its salt form;
   in its non-surfactant form, wherein the non-surfactant form is a tertiary amine comprising a hydrophobic portion, wherein said tertiary amine reversibly converts to a salt form following contact with an ionizing trigger gas that comprises CO₂, CS₂, COS, or a mixture thereof, at a pressure and an amount sufficient to convert all or a substantial portion of the amine to said salt, wherein the total pressure of the ionizing trigger gas is approximately ambient pressure; or
   in a mixture of its surfactant form and its non-surfactant form; and
(c) means for introducing
   (i) the vacuum, heat and/or a flushing gas;
   (ii) the ionizing trigger gas; or
   (iii) both (i) and (ii).

### BRIEF DESCRIPTION OF THE FIGURES

For a better understanding of the present invention, as well as other aspects and further features thereof, reference is made to the following description which is to be used in conjunction with the accompanying drawings, where:

FIG. 1A depicts three cycles of the reversibility of charge in 20 mL of 20.0 mM ethanolic solutions of 2a (▴) and 3a (♦) spiked with 200 μL of water and FIG. 1B graphically depicts the change in conductivity of wet ethanolic solutions of 1a (▪), 2a (▴), and 3a (♦) at room temperature when CO₂ followed by Ar are bubbled through the solutions;

FIG. 2 graphically depicts the volume percent of PMMA particles below 1 μm as a function of time during destabilization using air at 65° C. (♦), 40° C. () and room temperature (▴) in a latex synthesized according to the conditions in Table 1, entry 11;

FIG. 3 graphically depicts the change in ζ-potential, over time, of latexes destabilized using Ar and heat (65° C.); the initial latexes were synthesized using (a) 1.0 mol % 1b and 0.25 mol % VA-061, (b) 0.07 mol % 1b and 0.07 mol % VA-061, (c) 1.0 mol % 3a and 0.25 mol % VA-061 and (d) 1.0 mol % 2a and 0.25 mol % VA-061; and

FIG. 4 graphically depicts the change in ζ-potential, over time, during the destabilization of latexes synthesized (♦) with no CTAB (Table 1, entry 7) and (▪) with CTAB (0.016 mol % with respect to monomer, Table 3, entry 5) as a co-surfactant.

### DETAILED DESCRIPTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

As used herein, “aliphatic” refers to hydrocarbon moieties that are straight chain, branched or cyclic, may be alkyl, alkenyl or alkynyl, and may be substituted or unsubstituted. “Long chain aliphatic” or “higher aliphatic” refers to an aliphatic having five or more backbone carbons, for example a C₅ to C₂₅ aliphatic or a C₈ to C₂₅ aliphatic or a C₁₂ to C₂₅ aliphatic.

As used herein, a “siloxyl” group or chain includes {Si(aliphatic)₂-O} units, {Si(aryl)₂-O} units, {Si(aliphatic)(aryl)-O} units or combinations thereof. A preferred siloxyl group has {Si(CH₃)₂-O} units. “Long chain”,and “higher siloxyl” refer to the same numbers of SiO units as discussed for C units above in defining the term “aliphatic”.

Conveniently, in some discussions hereinbelow, the term “aliphatic/siloxyl” is used as shorthand to encompass “aliphatic” and/or “siloxyl” moieties.

As used herein, “heteroatom” refers to non-hydrogen and non-carbon atoms, such as, for example, O, S, and N.

“Substituted” means having one or more substituent moieties whose presence does not interfere with the desired reaction. Examples of substituents include alkyl, alkenyl, alkynyl, aryl, aryl-halide, heteroaryl, cycloalkyl (non-aromatic ring), Si(alkyl)₃, Si(alkoxy)₃, halo, alkoxyl, amino, alkylamino, alkenylamino, amide, amidine, hydroxyl, thioether, alkylcarbonyl, alkylcarbonyloxy, arylcarbonyloxy, alkoxycarbonyloxy, aryloxycarbonyloxy, carbonate, alkoxycarbonyl, aminocarbonyl, alkylthiocarbonyl, phosphate, phosphate ester, phosphonato, phosphinato, cyano, acylamino, imino, sulfhydryl, alkylthio, arylthio, thiocarboxylate, dithiocarboxylate, sulfate, sulfato, sulfonate, sulfamoyl, sulfonamide, nitro, nitrile, azido, heterocyclyl, ether, ester, silicon-containing moieties, thioester, or a combination thereof. The substituents may themselves be substituted. For instance, an amino substituent may itself be mono or independently disubstitued by further substituents defined above, such as alkyl, alkenyl, alkynyl, aryl, aryl-halide and heteroaryl cycloalkyl (non-aromatic ring).

As used herein, an “emulsion” is a heterogeneous mixture consisting of at least one immiscible liquid dispersed in another in the form of small droplets.

As used herein, the term “wet” in reference to a chemical (e.g., acetonitrile, diethyl ether) means that no techniques were employed to remove water from the chemical.

As used herein, the term zeta-potential or -potential refers to the potential difference between a dispersion medium and the stationary layer of fluid attached to a dispersed particle in a colloid, such as an emulsion. The zeta potential value can be related to the stability of an emulsion. Generally, a high zeta potential is indicative of stability. When the potential is low, attraction exceeds repulsion and the dispersion will break. Emulsions having high zeta potential (negative or positive) are electrically stabilized.

As used herein, the term “insoluble” refers to a poorly solubilized solid in a specified liquid such that when the solid and liquid are combined a heterogeneous mixture results. It is recognized that the solubility of an “insoluble” solid in a specified liquid might not be zero. The use of the terms “soluble”, “insoluble”, “solubility” and the like are not intended to imply that only a solid/liquid mixture is intended. For example, a statement that a substance is soluble in water is not meant to imply that the substance must be a solid; the possibility that the substance may be a liquid is not excluded.

As used herein, the term “miscibility” is a property of two liquids that when mixed provide a homogeneous solution. In contrast, “immiscibility” is a property of two liquids that when mixed provide a heterogeneous mixture, for instance having two distinct phases (i.e., layers).

As used herein, “immiscible” means unable to merge into a single phase. Thus, two liquids are described as “immiscible” if they form two phases when combined in a proportion. This is not meant to imply that combinations of the two liquids will be two-phase mixtures in all proportions or under all conditions. The immiscibility of two liquids can be detected if two phases are present, for example via visual inspection. The two phases may be present as two layers of liquid, or as droplets of one phase distributed in the other phase. The use of the terms “immiscible”, “miscible”, “miscibility” and the like are not intended to imply that only a liquid/liquid mixture is intended. For example, a statement that a substance is miscible with water is not meant to imply that the substance must be a liquid; the possibility that the substance may be a solid is not excluded.

The term “switched,” as used herein, means that the physical properties and in particular the surfactant properties, have been modified. “Switchable” means able to be converted from a first state with a first set of physical properties, e.g., a first “off” or non-surfactant state in which the switchable moiety is neutral (not ionized or in a salt form), to a second “on” or surfactant state in which the switchable moiety is ionized or in a salt form. A “trigger” is a change of conditions (e.g., introduction or removal of a gas, change in temperature) that causes a change in the physical properties, e.g., surfactant properties. A trigger is referred to herein as a “neutralizing” trigger if it facilitates a change in a switchable compound from its surfactant form to its non-surfactant form, irrespective of whether the compound contains one or more other charged functional groups. A trigger is referred to herein as an “ionizing” trigger if it facilitates a change in a switchable compound from its non-surfactant form to its surfactant form. The term “reversible” means that the reaction can proceed in either direction (backward or forward) depending on the reaction conditions. For greater clarity, the term “switchable surfactant compound” is used herein to refer to a switchable compound in both its “on”, surfactant form and its “off”, non-surfactant form.

As used herein, “gases that liberate hydrogen ions” is a phrase used to refer to ionizing trigger gases that fall into two groups. Group (i) includes gases that liberate hydrogen ions in the presence of a base, for example, HCN and HCl (water may be present, but is not required). Group (ii) includes gases that when dissolved in water react with water to liberate hydrogen ions, for example, CO₂, NO₂, SO₂, SO₃, CS₂ and COS. For example, CO₂ in water will produce HCO₃⁻ (bicarbonate ion) and CO₃²⁻ (carbonate ion) and hydrogen counterions, with bicarbonate being the predominant species. One skilled in the art will recognize that the gases of group (ii) will liberate a smaller amount of hydrogen ions in water in the absence of a base, and will liberate a larger amount of hydrogen ions in water in the presence of a base.

A gas that liberates hydrogen ions is employed as a trigger to turn “on” a switchable surfactant as described herein. Preferred gases that liberate hydrogen ions are those wherein the surfactant switches to its “off” form when the same gas is expelled from the environment. CO₂ is particularly preferred. Hydrogen ions produced from dissolving CO₂ in water protonate the “off” form of a switchable surfactant, thus turning it “on”. In such solution, the counterion for the positively charged surfactant is predominantly bicarbonate. However, some carbonate ions are also present in solution and the possibility that, for example, two surfactant molecules, each with a single positive charge, associate with a carbonate counterion is not excluded. When CO₂ is expelled from the solution, the surfactant is deprotonated and thus converted to its “off” form.

Of group (ii) gases that liberate hydrogen ions, CS₂ and COS are expected to behave similarly to CO₂ to form surfactants that are reversibly switchable. However, it is expected that the reverse reaction, i.e., from “on” surfactant to “off”, may not proceed as easily to completion as with CO₂. In some embodiments of the invention, alternative gases that liberate hydrogen ions are used instead of CO₂, or in combination with CO₂, or in combination with each other. Alternative gases that liberate hydrogen ions are less preferred because of the added costs of supplying them and recapturing them, if recapturing is appropriate. However, in some applications one or more such alternative gases may be readily available and therefore add little to no extra cost. Group (i) gases HCN and HCl are less preferred triggers because of their toxicity and because reversibility would likely require a strong base.

As used herein, “flushing gases” are neutralizing triggers that are gases that do not liberate hydrogen ions in the presence of a base, and that when dissolved in water do not react with water to liberate hydrogen ions even in the presence of a base. Thus, this term is used to distinguish such gases from gases that liberate hydrogen ions as discussed above, and there is no intended implication from the word “flushing” that movement is absolutely required. As described in detail below, a flushing gas employed in a switchable surfactant system, is used to expel a gas that liberates hydrogen ions from a mixture. Examples of flushing gases are N₂, air, air that has had its carbon dioxide component substantially removed, argon, oxygen, He, H₂, N₂O, CO, ethane, ethylene, propane, methane, dimethylether, tetrafluoroethylene, and combinations thereof.

A gas that liberates hydrogen ions can be expelled from a solution including surfactant by simple heating or by applying a vacuum. Alternatively and conveniently, a flushing gas may be employed to expel a gas that liberates hydrogen ions (e.g., group (ii) gas) from a solution including surfactant. This shifts the equilibrium from “on” form to “off” form.

Preferred flushing gases are N₂, air, air that has had its carbon dioxide component substantially removed, and argon. Less preferred flushing gases are those gases that are costly to supply them and/or to recapture, where appropriate. However, in some applications one or more flushing gases may be readily available and therefore add little to no extra cost. In certain cases, flushing gases are less preferred because of their toxicity, e.g., carbon monoxide.

Air is a particularly preferred choice as a flushing gas according to the invention, where the CO₂ level of the air (today commonly 380 ppm) is sufficiently low that an “on” surfactant in not maintained in “on” form. Untreated air is preferred because it is both inexpensive and environmentally sound. In some situations, however, it may be desirable to employ air that has had its carbon dioxide component substantially removed as a flushing gas. By reducing the amount of CO₂ in the flushing gas, potentially less surfactant may be employed. Alternatively, some environments may have air with a high CO₂ content, and such flushing gas would not achieve complete switching of “on” surfactant to “off”. Thus, it may be desirable to treat such air to remove enough of its CO₂ for ready switching off of the surfactant.

Gas that liberates hydrogen ions can be provided from any convenient source, for example, a vessel of compressed CO_{2(g)} or as a product of a non-interfering chemical reaction. Flushing gas may be provided from any convenient source, for example, a vessel of compressed flushing gas (e.g., N_{2(g)}, air that has insufficient carbon dioxide to turn on said surfactant or maintain it in surfactant form, air which has had its CO_{2(g)} substantially removed, Ar_{(g)} or as a product of a non-interfering chemical reaction. Conveniently, such exposure is achieved by bubbling the gas through the mixture. However, it is important to recognize that heating the mixture is an alternative method of driving off the CO₂, and this method of converting the surfactant to non-surfactant and means for heating the mixture can be incorporated in the switchable surfactant system described herein. In certain situations, especially if speed is desired, both bubbling and heat can be employed.

Switchable Cationic Surfactants

The design of the head group of switchable cationic surfactants can dramatically affect the performance of the switchable surfactant. Using a guanidine head group^{18,19} increases the basicity and the heat of protonation, makes the surfactant usable at higher temperatures, makes it more difficult to switch off the surfactant, and destroys the demulsifying ability of the neutral form. Imidazoline and aryl-substituted acetamidine head groups have lower basicity and heat of protonation, are easier to switch off, and the aryl acetamidine has excellent demulsifying ability.¹⁸

The present application provides a switchable surfactant that can be reversibly and readily switched between surfactant (“on”) and non-surfactant (“off”) forms by applying a trigger. The surfactant includes a cationic moiety and can conveniently be isolated as a salt with an anionic counterion such as, for example, a bicarbonate ion. A non-surfactant means a compound with little or no surface activity. The switchable surfactant compounds described herein are tertiary amines, or their corresponding salts, that have now been found to turn “on”, or switch to their salt form, in the presence of water, with the addition of an ionizing trigger gas that comprises a gas that liberates hydrogen ions, such as CO₂, without the need to introduce the ionizing trigger gas at high pressure. In particular, the ionizing trigger gas comprises a gas that liberates hydrogen ions, such as CO₂, at an amount and pressure sufficient to convert all or a significant portion of the switchable surfactant compound to its “on” form (salt), without taking steps to artificially elevate the pressure of the ionizing trigger gas beyond ambient pressure. It should be recognized, however, that by introducing a trigger gas stream, there may be some transient elevation of pressure but since the system is not a closed system, the elevated pressure dissipates. Furthermore, the elevated pressure would not reach what is generally understood in the field by the term “high pressure”. The partial pressure of the gas that liberates hydrogen ions, such as CO₂, will vary depending on the concentration in the ionizing trigger gas. For example, in some instances, pure CO₂ is used as an ionizing trigger gas, however, in other instances the CO₂ is only one component of the ionizing trigger gas.

As used herein, “ambient pressure” is used to refer to a pressure that is not significantly outside the range of total pressures observed in weather at ground level (i.e., not significantly outside the range of about 87 kPa to about 109 kPa). For example, when applied to CO₂, the term “ambient pressure” means that the partial pressure of CO₂ is not significantly outside the range of total pressures observed in weather at ground level (i.e., not significantly outside the range of about 87 kPa to about 109 kPa).

In certain embodiments, it can be necessary to increase the amount of water present in the system in order to readily convert the tertiary amine switchable surfactant to its “on” form (salt).

The tertiary amine-based surfactants also turn off easily and quickly. In one embodiment, the switchable surfactants exhibit fast switching from their “on” forms to their “off” forms and readily switch from their “off” form to their “on” form by application of atmospheric pressure CO₂ as the ionizing trigger.

Also provided is a switchable surfactant system that comprises a switchable surfactant, in its “on” or “off” form, and a trigger or means for introducing a trigger for switching the switchable surfactant from its “on” form to its “off form” or vice versa. The switchable surfactant system can additionally comprise other components based on, for example, the application of the system.

The switchable surfactant compound used in the methods and systems described herein, can have the structure of Formula I, when in its “off” form:

R¹R²NR³ I

where
at least one of R¹, R², and R³ is a hydrophobic moiety selected from the group consisting of higher aliphatic moiety, higher siloxyl moiety, higher aliphatic/siloxyl moiety, aliphatic/aryl moiety, siloxyl/aryl moiety, and aliphatic/siloxyl/aryl moiety; and
the rest of R¹, R², and R³ are selected from the group consisting of a substituted or unsubstituted C₁ to C₄ alkyl group, (SiO)₁ to (SiO)₂, and Cₙ(SiO)ₘ where n is a number from 0 to 4 and m is a number from 0 to 2 and n+m≦4;
where the higher aliphatic and/or siloxyl moiety is a hydrocarbon and/or siloxyl moiety having a chain length of linked atoms corresponding to that of C₈ to C₂₅, which may be substituted or unsubstituted, and may optionally contain one or more SiO unit, one or more aryl or heteroaryl groups, one or more ether linkages, one or more ester linkages or combinations of two or more of these, and wherein the hydrophobic moiety is not substituted with an aromatic group or an electronegative atom on the carbon alpha to the amine nitrogen or a fluorine atom on the carbon beta to the amine nitrogen and wherein an aryl or heteroaryl group is not directly attached to the amine nitrogen.

In particular embodiments, the hydrophobic moiety is a higher aliphatic moiety that is a C₅ to C₂₅ aliphatic or a C₈ to C₂₅ aliphatic or a C₁₂ to C₂₅ aliphatic, such as an octyl, nonyl, decyl, undecyl, dodecyl, tridecyl, tetradecyl, pentadecyl or eicosyl group, and the rest of R¹, R², and R³ are selected from the group consisting of a substituted and unsubstituted C₁ to C₄ alkyl groups.

Design of the hydrophobic group makes it possible to control the solubility, the partitioning behaviour, and/or the ecotoxicity of the switchable surfactants described herein. In most applications, the ecotoxicity of the surfactant should be low because surfactant use is often associated with some release to the environment. For example, the acute toxicity of surfactants to rainbow trout (Oncorhyncus mykiss) was found to correlate linearly with the logKow (octanol/water partition coefficient), such that switchable surfactants haing lower logK_{ow} values were the least ecotoxic.³¹

Reuse and recycling of the switchable surfactants described herein are convenient, with attendant economic benefits. In certain applications, it may be advantageous to turn off the surfactant and then turn it back on again. For example, the surfactant could be turned on to stabilize an emulsion, and turned off to allow for separating and decanting of the hydrophobic and/or hydrophilic layers and/or isolation of a precipitate. In its “off” form, the switchable surfactant will partition into the non-aqueous phase, which can be decanted. The surfactant can be reused by adding aqueous solution (e.g., fresh or recycled) and converting the non-surfactant to its surfactant form. The newly formed surfactant will then partition into the aqueous phase.

If isolation of a switchable surfactant of the invention is desired, it can be isolated in either of its forms by taking advantage of their contrasting solubilities. When the “on” (salt) form is turned off, the switchable surfactant separates from aqueous solution, allowing for its easy recovery. Alternatively, the “on” form precipitates from non-aqueous solution, and is conveniently recovered.

Use of the Switchable Surfactant and Switchable Surfactant Systems

The present application also provides a method for separating two immiscible liquids using a reversibly switchable surfactant as described herein. The application further provides a method for maintaining or stabilizing an emulsion using a reversibly switchable surfactant as described herein. The surfactant can then be turned off and the immiscible liquids separated.

In certain embodiments, two immiscible liquids are (1) water or an aqueous solution and (2) a water-immiscible liquid such as a solvent, a reagent, a monomer, an oil, a hydrocarbon, a halocarbon, or a hydrohalocarbon. The water-immiscible liquid could be pure or a mixture. Solvents include, for example and without limitation, alkanes, ethers, amines, esters, aromatics, higher alcohols, and combinations thereof. Monomers include, for example and without limitation, styrene, chloroprene, butadiene, acrylonitrile, tetrafluoroethylene, methylmethacrylate, vinylacetate, isoprene, and combinations thereof. Oils include, for example and without limitation, crude oil, bitumen, refined mineral oils, vegetable oils, seed oils (such as soybean oil and canola oil), fish and whale oils, animal-derived oils, and combinations thereof. Halocarbons include, for example and without limitation, perfluorohexane, carbon tetrachloride, and hexafluorobenzene. Hydrohalocarbons include, for example and without limitation, (trifluoromethyl)benzene, chlorobenzene, chloroform, chlorodibromomethane, partially fluorinated alkanes, and combinations thereof. A water-immiscible liquid could be a gas at standard temperature and pressure but a liquid or supercritical fluid at the conditions of the application. (Supercritical fluids, while not technically liquids, are intended to be included when liquids are discussed.)

In other embodiments, two immiscible liquids are a more polar liquid and a less polar liquid. Polar compounds have more hydrogen bonding and/or greater dipole moments and/or charge separation. They include, for example, solvents, reagents and monomers such as alcohols (e.g., methanol, ethylene glycol, glycerol, vinyl alcohols), carboxylic acids (e.g., acrylic acid, methacrylic acid, acetic acid, maleic acid), nitriles (e.g., acetonitrile), amides (e.g., acrylamide, dimethylformamide), sulfoxides (e.g., dimethylsulfoxide), carbonates (e.g., propyl carbonate), sulfones (e.g., dimethylsulfone), ionic liquids, and other highly polar liquids, e.g., hexamethylphosphorus triamide, nitromethane, 1-methylpyrrolidin-2-one, sulfolane, and tetramethylurea. Less polar compounds have less hydrogen bonding and/or lesser dipole moments and/or less charge separation. Less polar liquids include solvents, reagents, monomers, oils, hydrocarbons, halocarbons, and hydrohalocarbons as described previously. These could be pure liquids, mixtures or solutions.

In other embodiments, two immiscible liquids are two immiscible aqueous solutions, for example, an aqueous solution of polyethylene glycol and an aqueous solution of a salt.

In some embodiments, the switchable surfactant can be used with a mixture of a liquid and a water insoluble solid.

The present application provides a convenient system to control the presence or absence of a tertiary amine-based surfactant in a mixture such as an emulsion. Thus, it is useful in many industrial applications. In the oil industry, where mixtures of crude oil and water must be extracted from subterranean cavities (water is even pumped into an underground oil reservoir), emulsions can first be stabilized with a surfactant of the invention. Subsequently, the emulsion can be conveniently and readily broken by bubbling the emulsion with an appropriate flushing gas to turn off the surfactant. The use of switchable surfactants in enhanced oil recovery (EOR) could allow for simpler recovery of the emulsified oil, even at the production point. Oil field operations are used to dealing with CO₂ as a diluent, and some EOR processes (e.g. the water-alternating-gas or “WAG” process) use water, high pressure CO₂, and surfactants together.^{32,33} Emulsions in the product oil impede separation, a problem which could be eliminated by a reversibly switchable surfactant.

Also, the switchable surfactant could be used in one of its forms to stabilize an emulsion of heavy crude oil or bitumen in water for the purposes of pipelining the fuel. After arriving at the destination, the emulsion would be broken by switching the surfactant to its other form. For high acid-content oils, the surfactant without CO₂ would be used to stabilize the emulsion and CO₂ addition would be used to break the emulsion. For low acid-content oils, the surfactant with CO₂ would be used to stabilize the emulsion and CO₂ removal would be used to break the emulsion.

The switchable surfactant system according to the invention can facilitate water/solid separations in mining. In mineral recovery, switchable surfactants may be suitable as flotation reagents which are mineral-specific agents that adsorb to the mineral particles to render them hydrophobic and therefore likely to float upon aeration. Flotation reagents designed on the basis of switchable surfactants could be readily removed from minerals and recycled.

The switchable surfactant system described herein can be employed for extraction of a hydrophobic substance from a mixture or matrix using a combination of water or aqueous solution and surfactant, for example, oil from porous rock, spilled oil from contaminated soil, desirable organic compounds from biological material (plant or animal), ink from paper, dirt from clothing. Analogously, the application provides a method for extracting a hydrophilic substance from a mixture or matrix using a combination of organic solvent and surfactant, for example, caffeine from coffee, metal salts from soil, salts or polyols (e.g., sugars) from organic mixtures. In each case, the extracted substance can be recovered from solvent by turning off the switchable surfactant.

Switchable surfactants described herein can be useful in water/solvent separations in biphasic chemical reactions. An example is homogeneously-catalyzed reactions in organic/aqueous mixtures. Initially, with the surfactant “switched on”, a water-soluble homogeneous catalyst dissolved in water could be used to catalyze reactions such as, for example, hydrogenation or hydroformylation of organic substrates such as olefins in an immiscible organic phase. With appropriate agitation or shear to create an emulsion, the reaction should be fairly rapid due to enhanced mass transfer and contact between the two phases. After the reaction is complete, the surfactant is switched off to break the emulsion, and then the two phases are separated. The surfactant, being at this point a nonpolar organic molecule, will be retained in the organic phase but can be readily precipitated from that solution by being switched back on again. The switchable surfactant can then be recovered by filtration so that it can be reused and will not contaminate the product or waste streams.

Reversibly switchable surfactants can be useful additives in polymerization reactions (see Example 1). A switchable surfactant can be used in an emulsion or microsuspension polymerization of water insoluble polymers. This permits manufacture of very high molecular weight polymers which are recovered from solution by switching off the surfactant, filtering and drying the obtained solid. In general, such high molecular weight polymers are difficult to produce in a solution polymerization process without surfactants because of their tendency to form gels. Switchable surfactants described herein could protect surfaces of nanoparticles, colloids, latexes, and other particulates during synthesis and use. In the absence of a coating of surfactant, such particles tend to agglomerate. But, in many cases, once the synthesis is complete, the presence of surfactant is no longer desirable. For example, in preparation of supported metal catalysts, complete removal of surfactant is desired, but it is difficult with non-switchable surfactants, since they bind strongly to the surface.

When polymers are prepared by emulsion or microsuspension polymerization, it is preferred that the particle size of the resulting solid polymer be small (i.e., 1 μm), so that (a) the polymer particles will not settle out during transport and/or storage, and (b) high conversion of monomer is obtained. Later, when the polymer is to be isolated from the aqueous suspension, it is preferred that the particle size be larger because that will make isolation of the polymer by settling or filtration easier and more effective. Small particles would either pass entirely through a filter, clog up the filter, or make it necessary to use a very fine and therefore inefficient filter. Accordingly, in such applications, a switchable surfactant would be “on” to keep particle size small during formation, transport and storage of the (latex) suspension but “off” before and during the isolation of the polymer.

Thus, small particle size and a narrow particle size distribution are desirable, for example, in the field of latex production. Latex is a surfactant stabilized dispersion of polymeric particles in water. Current industrial methods to isolate such polymeric product involve addition of salts to coagulate the dispersion, followed by filtration and washing to remove surfactant and metal salts from the product. When the washing step is ineffective in removing surfactant, the resulting polymers are hydrophilic, which may be undesirable. An alternative method is polymerization in organic solvent. Here, removal of the solvent is time-consuming, costly, and difficult because of the product's high viscosity.

Whether deactivation of the surfactant is desired, or its complete removal, switchable surfactants present advantages. Their presence would allow the desired polymer particle size to be achieved while allowing the polymer to precipitate from solution when the switchable surfactant is turned “off.”

It should also be noted that switchable surfactants described herein have application in latex paints and other coating formulations since they will readily turn off when the paint or coating is applied to a surface in air.

A switchable surfactant as described herein can be used in inverse emulsion polymerization of water soluble polymers. In general, water-soluble polymers and/or hygroscopic polymers are prepared by polymerization of an inverse emulsion of a monomer in a hydrophobic solvent. An inverse emulsion has as its continuous phase an organic solvent and has micelle cores present to surround a hydrophilic monomer. With the presence of a switchable surfactant, this inverse emulsion mixture is stabilized and a polymerization reaction is possible. At completion of the polymerization, the surfactant is switched off by application flushing gas to the mixture. The “off” surfactant then partitions into the organic solvent and the polymer precipitates. This permits manufacture of very high molecular weight polymers which are recovered from the inverse emulsion and dried to produce a product (dry-form high MW or branched polymers) that could not be achieved in a standard solution polymerization process because of the tendency for such products to form gels. Low HLB (hydrophile/lipophile balance) switchable surfactants are preferred in this application, and the surfactant should not act as a chain-transfer agent. Polymers that are expected to be readily prepared by this method include, for example, polyacrylamide, polyacrylic acid, polymethacrylic acid, alkali metal salts of polyacrylic acid or polymethacrylic acid, tetraalkylammonium salts of polyacrylic acid or polymethacrylic acid, polyvinylalcohols, and other hygroscopic polymers or polymers that are substantially soluble in water or that swell in water.

In some polymerization applications, the surfactant becomes a part of the polymeric particle product, allowing the particles to be precipitated and resuspended repeatedly.

Switchable surfactants described herein can find use as transient antifoams in distillation columns, replacing traditional cationic surfactants.

Another application for reversibly switchable surfactants is protection and deprotection of nanoparticles. Nanoparticles and other materials are frequently temporarily protected during synthetic procedures by traditional surfactants. They could be more readily deprotected and cleaned if reversibly switchable surfactants were used.

The switchable surfactants, systems and methods of use thereof as described herein can lessen environmental impact of industrial processes, both by saving energy normally expended during separations and by improving the purity of wastewater emitted from production facilities. The presence of a switchable surfactant in waste effluent could lead to significantly less environmental damage since effluent can be readily decontaminated by treatment with the appropriate trigger prior to its release into the environment.

To gain a better understanding of the invention described herein, the following examples are set forth. It should be understood that these examples are for illustrative purposes only. Therefore, they should not limit the scope of this invention in any way.

### EXAMPLES

### Example 1

### Emulsion Polymerization of Methyl Methacrylate (“MMA”).

Emulsion polymerization of MMA was carried out using a long chain alkyl tertiary amine and an acetamidine, to study the aggregation time of the resultant polymer latexes. The two surfactant precursors chosen were the long chain alkyl tertiary amine, 2a, and the alkyl phenyl dimethylacetamidine, 3a (Scheme 1 above). These compounds were chosen based on the reported aqueous pK_{aH} (pKₐ of the conjugate acid of the nitrogenous bases) values of their shorter alkyl chain analogues (10.0 for N,N-dimethylbutylamine²⁷ and 10.8 for N′-tolyl-N,N-dimethylacetamidine, ²⁸ compared to 12.2 for 1a).

Experimental

Reagents.

Carbon dioxide (medical grade) was used as received from Praxair. Methyl methacrylate (MMA) (99%) containing monomethyl ether hydroquinone (MEHQ) as a polymerization inhibitor was purchased from Aldrich. MEHQ was removed using an inhibitor removal column, which was also purchased from Aldrich. 2,2′-Azobis[2-(2-imidazolin-2-yl)propane] (VA-061) and 2,2′-azobis[2-(2-imidazolin-2-yl)propane]dihydrochloride (VA-044) were purchased from Wako Pure Chemicals (Osaka, Japan). N,N-Dimethyl-N-dodecylamine (90%, Alfa Aesar), 4-decylaniline (98%, Alfa Aesar), cetyltrimethylammonium bromide (CTAB, Sigma Aldrich) and dimethylacetamide dimethyl acetal (90%, TCI) were purchased and used as received. Disponil® A 3065 was purchased from Cognis as a 30 wt % solution of linear fatty alcohol ethoxylates in water. N′-(4-decylphenyl)-N,N-dimethylacetamidine (3a) was synthesized by a previously developed procedure.¹⁸ The yield was determined by ¹H-NMR spectroscopy to be 90%. The major impurity is suspected to be N-(4-decylphenyl)-O-methylacetimidate (10%).²⁰. This mixture was not purified before its use as a surfactant.

Assessing Surfactant Switchability.

Conductivity measurements of 20.0 mM solutions of 1b-3b in ethanol (spiked with 200 μL of water) were obtained using a Jenway conductivity meter 4071. CO₂ was bubbled through the solution using a needle at a flow rate of 70 mL min⁻¹, and the conductivity change over time was measured at room temperature (23° C.) until a maximum was reached. Air was subsequently bubbled through the solution using a needle at a flow rate of 70 mL min⁻¹. This process was repeated for 3 cycles. As a control, the conductivity of a solution of water (200 μL) in ethanol (15 mL) was determined and observed to change by less than 5 μScm⁻¹ upon CO₂ application.

Conversion to Bicarbonate.

Carbon dioxide was bubbled through a solution of 2a or 3a (0.1 mmol) in MeOD-d₄ (0.7 mL) spiked with 50 μL H₂O for 5 minutes at room temperature and at 65° C. and ¹H-NMR and ¹³C-NMR spectra were recorded. ¹H-NMR and ¹³C-NMR spectra of the neutral molecule as well as the hydrochloride salt of each were also recorded. The presence of peaks at 161 ppm (carbon of HCO₃⁻), and ˜164 ppm (the cationic carbon) in the ¹³C spectra was taken as evidence of bicarbonate salt formation. Conversion to 2b and 3b was quantitatively determined at room temperature and at 65° C. using ¹H-NMR. Each spectrum (2a, 2a.HCl, 2b, 3a, 3aHCl and 3b) was internally referenced against the signal for the methyl group at the end of the alkyl chain. The chemical shifts of protons located close to the headgroup of the surfactant were determined. The HCl salt and neutral surfactants were assumed to be 100% and 0% protonated, respectively. Equations were developed correlating the chemical shift to % conversion and using the chemical shift obtained from the spectra of carbonated 2a and 3a, % conversion to the bicarbonate salt was determined.

Emulsion Polymerization and Destabilization.

Compound 2a (0.078 mmol, 17 mg) or 3a (0.078 mmol, 26 mg) was added to MMA (31.3 mmol, 3.13 g) in a 20 mL scintillation vial. This mixture was added to a round bottom flask containing water (18.0 g) that was pre-saturated with CO₂ by bubbling the gas into the water using a needle. This mixture was allowed to stir for 30 min. The initiator, VA-061 (20 mg), was added to a separate 20 mL scintillation vial, 2.0 mL of water was added and the solid was dissolved by adding carbon dioxide to form a water soluble bicarbonate salt.²² This solution was added to the round bottom flask, which was equipped with a condenser, and was allowed to stir at 65° C. for 2 h while continuously bubbling CO₂ through the mixture using a needle. To destabilize the polymer latex that was formed, the CO₂ was removed from the system by sparging with air or Ar through a needle at various temperatures while stirring.

Colloid Characterization.

Polymer conversion was determined gravimetrically by removing 1-2 g samples from the reaction mixture using a syringe and allowing them to dry under a flow of air for 24 h and then in the oven for 24 h to determine the solid content of the latex. Conversion stopped after 1 h. Latex particle sizes were determined using a Malvern Zetasizer Nano ZS (size range of 0.6 nm to 8.9 μm) and/or a Malvern Mastersizer 2000 equipped with a Hydro2000S optical unit (size range of 0.05 μm to 2000 μm). ζ-potential measurements were obtained using the Zetasizer ZS. To assess the effectiveness of latex destabilization, the Mastersizer 2000 was used to track changes in particle size over time. Measurement with the Mastersizer 2000 requires a large sample dilution with de-ionized water, which causes quasi-stable particles to aggregate during the measurement, giving irreproducible results. Therefore, the mixture of non-ionic surfactants called Disponil® A 3065 was added to the sample just prior to its addition to the Mastersizer to prevent particle aggregation and preserve the original particle size distribution during analysis. Samples for ζ-potential measurement were prepared by diluting 1 drop of the latex into ˜1 mL of DI water, and this solution was added to a clear folded capillary cell.

Results and Conclusions

Surfactant Switchability.

Tertiary amine 2a was purchased from Alfa Aesar and used without further purification, while 3a was synthesized according to a previously developed procedure¹⁸. Formation of the bicarbonate salts was achieved by purging CO₂ through solutions of 2a and 3a in various solvents. Bicarbonate formation was confirmed by the presence of a peak at ˜162 ppm in the ¹³C-NMR spectra of solutions of 2a and 3a in CO₂ saturated MeOD-d₄. Conversion to 2b and 3b was 98% and 76% at room temperature and 54% and 47% at 65° C., respectively. Isolation of the bicarbonate salts was unsuccessful; therefore, they were formed in situ when used for emulsion polymerization.

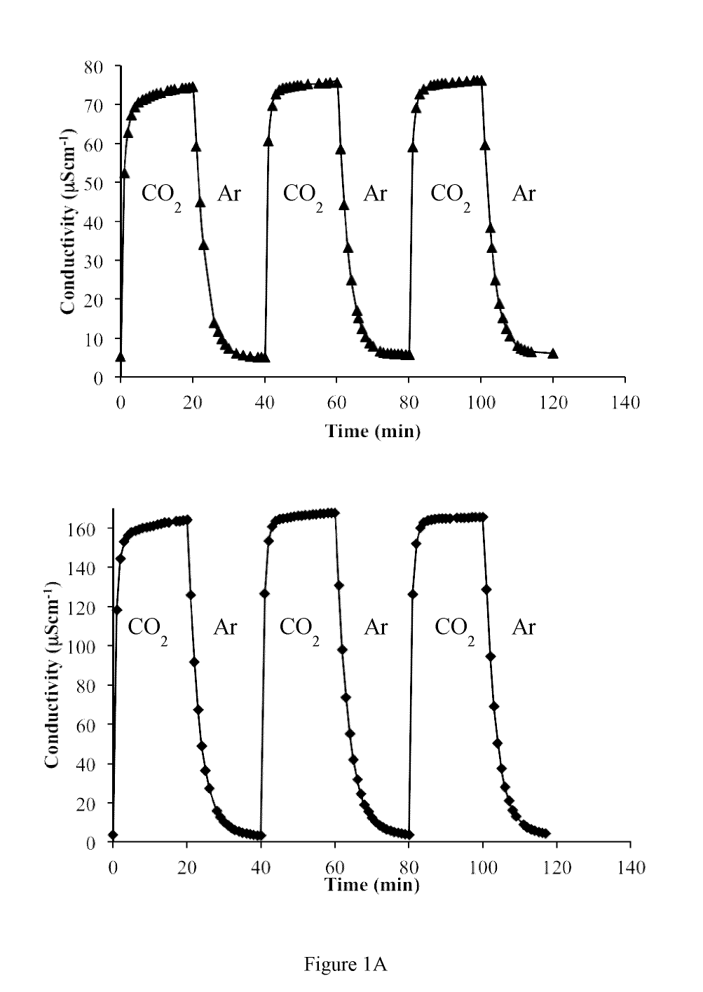

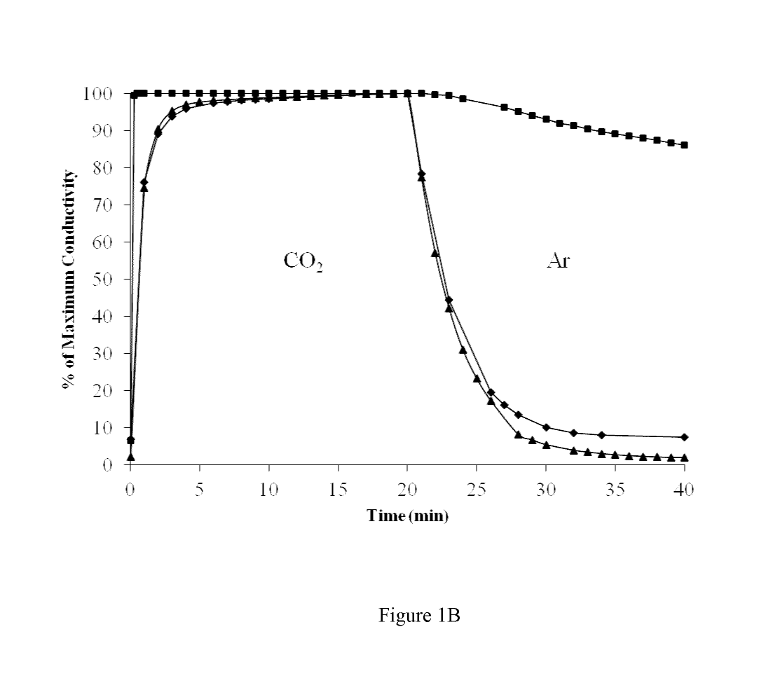

Reversibility of the switching process was demonstrated by bubbling CO₂ followed by argon through solutions of 2a and 3a in wet ethanol and measuring the change in conductivity of the solution. The CO₂/Ar cycle was carried out three times to show repeatability of switching (FIG. 1A). The conductivity increased almost immediately when CO₂ was bubbled through the solution and decreased again when sparged with Ar. The experiment was also carried out using 1a, and the average results of the three cycles for each surfactant can be seen in FIG. 1B. The application of Ar to 2b and 3b causes a rapid reduction in conductivity, and the original solution conductivity is restored after only 20 min, indicating that the surfactant is fully converted to the uncharged form. In the case of lb, after 20 min, the conductivity is only reduced by 14%, indicating that most of the surfactant remains in the charged form. These results demonstrate that surfactants 2b and 3b would be more effective than 1b in applications where rapid removal of charge, and consequently, surfactant effect, is desired.

Emulsion Polymerization.

Emulsion polymerization was carried out using surfactants 2b and 3b, using an initial concentration of 13.5 wt % MMA to show that stable latexes could be obtained. By investigating the effect of surfactant and initiator concentrations, temperature and type of surfactant on the resultant particle size and ζ-potential of the latex, aspects of surfactant behavior in emulsion polymerization systems can be addressed (Tables 1 and 2). With the same surfactant type, as the surfactant concentration decreases, the particle size increases, which is expected due to the decrease in the number of particles that can be stabilized. Unexpected, however, was the increase in particle size with increasing initiator concentration that occurred with both 2b and 3b, but not 1b²² (Table 1, entries 2-4 and 8-10).

A large increase in particle size was noted for surfactants 2b and 3b versus 1b under equivalent conditions, which was most likely due to the decreased basicity of these surfactants. The polymerization reactions were carried out at 65° C., and the ratio of charged to uncharged form of the surfactant was expected to be less in the case of the 2b and 3b (versus 1b), effectively decreasing the amount of surfactant available for particle stabilization. This hypothesis was tested by carrying out the emulsion polymerization using the hydrochloride salts of 2a and 3a (Table 2, entries 3 and 7) because these surfactants should be permanently charged; and it was found that much smaller particles (45 and 34 nm versus 275 and 316 nm) were produced. This shows that the large particle size (in the cases where surfactants 2b and 3b are used) is not due to the decreased ability of the surfactant molecules with these head groups to pack on the particle's surface, but is likely due to significant conversion of 2b and 3b to 2a and 3a under the polymerization conditions. In an attempt to make smaller particles, polymerization at 50° C. (to ensure greater ratios of 2b:2a and 3b:3a) was tested (Table 2, entry 4) but this increased reaction time and decreased initiator efficiency producing large particles. Interestingly, a significant decrease in particle size was noted when 2a or 3a were dissolved in the aqueous phase versus the monomer phase prior to polymerization (Table 2, entries 1 and 2). This may be due to a greater solubility of the surfactant in the monomer phase, causing some of the surfactant to remain in this phase, leaving it unavailable to stabilize growing particles during the polymerization. While surfactant lb can be used in very low concentrations (0.07 mol % of MMA) and still provide adequate stabilization, such a small concentration of 3b produces a latex containing very large particles with low conversion of monomer and significant amounts of coagulum (17%) (Table 1, entry 12).

TABLE 1
Variation in particle size and ζ-potential of PMMA particles synthesized using different
concentrations of 1b, 2b or 3b and VA-061.^{a}

| | | | | | | Zeta | |
|---|---|---|---|---|---|---|---|
| | Surfactant | Mol % Surfactant | Mol % | Particle Size^{d} | | Potential^{d} | Conversion |
| | Identity^{b} | Precursor added^{c} | VA-061^{c} | (nm) (PdI) | | (mV) | (%) |
| 1 | 1b | 1.0 | 0.25 | 46 ± 0.2 | (0.07) | 67 ± 3 | 100 |
| 2 | 2b | 1.0 | 1.0 | 408 ± 9 | (0.10) | 44 ± 1 | 91 |
| 3 | 2b | 1.0 | 0.5 | 347 ± 2 | (0.06) | 44 ± 0.4 | 93 |
| 4 | 2b | 1.0 | 0.25 | 275 ± 5 | (0.14) | 35 ± 0.7 | 94 |
| 5 | 2b | 0.5 | 0.5 | 352 ± 2 | (0.09) | 32 ± 0.6 | 85 |
| 6 | 2b | 0.5 | 0.25 | 308 ± 2 | (0.07) | 45 ± 3 | 93 |
| 7 | 2b | 0.25 | 0.25 | 397 ± 6 | (0.06) | 32 ± 1 | 86 |
| 8 | 3b | 1.0 | 1.0 | 465 ± 8 | (0.05) | 56 ± 1 | 92 |
| 9 | 3b | 1.0 | 0.5 | 334 ± 2 | (0.07) | 52 ± 2 | 90 |
| 10 | 3b | 1.0 | 0.25 | 316 ± 3 | (0.12) | 34 ± 4 | 96 |
| 11 | 3b | 0.25 | 0.25 | 369 ± 2 | (0.04) | 41 ± 2 | 78 |
| 12 | 3b | 0.07 | 0.07 | 852 ± 117 | (0.2) | 32 ± 2 | 72 |

^{a}Polymerization was carried out at 65° C. for 2 h, at 13.5 wt % MMA.
^{b}A blank run was also carried out using no surfactant and 0.25 mol % VA-061 and a stable latex was not formed.
^{c}With respect to MMA.
^{d}Ranges indicate the standard deviation in the particle size and ζ-potential measurements using the Zetasizer ZS.

TABLE 2
Variation in particle size and ζ-potential of PMMA particles synthesized by varying the
conditions under which polymerization was carried out.^{a}

| | Change in | | Particle Size^{b} (nm) | Zeta Potential^{b} | Conversion |
|---|---|---|---|---|---|
| | procedure | Surfactant | (PdI) | (mV) | (%) |
| 1 | None | 2b | 275 ± 5 (0.14) | 35 ± 0.7 | 94 |
| 2 | Surfactant dissolved | 2b | 222 ± 7 (0.08) | 42 ± 1 | 92 |
| | in aqueous phase | | | | |
| 3 | Hydrochloride | 2a•HCl | 45 ± 0.3 (0.08) | 46 ± 1 | 100 |
| | version of surfactant | | | | |
| | used | | | | |
| 4 | Polymerization | 2b | 363 ± 4 (0.04) | 45 ± 0.8 | 85 |
| | temperature is 50° C. | | | | |
| 6 | None | 3b | 316 ± 3 (0.12) | 34 ± 4 | 96 |
| 7 | Hydrochloride | 3a•HCl | 34 ± 0.5 (0.18) | 70 ± 6 | 100 |
| | version of surfactant | | | | |
| | used | | | | |

^{a}Polymerization was carried out with 13.5 wt % MMA (with respect to water), 1.0 mol % of 2a or 3a and 0.25 mol % of VA-061 (with respect to MMA), at 65° C. (unless otherwise noted);
^{b}Ranges indicate the standard deviation in the particle size and ζ-potential measurements using the Zetasizer ZS.

Three strategies were developed to promote the production of smaller particles: (i) using VA-044 as an initiator; (ii) adding CTAB (cetyltrimethylammonium bromide) as an extra stabilizer; and (iii) carrying out the reaction under increased CO₂ pressure. The results of these studies are summarized in Table 3.

The use of VA-044 as an initiator allowed the reaction to be carried out at lower temperatures (50° C.), while maintaining a high initiator decomposition rate. However, this initiator is a hydrochloride salt and would remain charged even after CO₂ is removed from the system. It has been previously shown that when VA-044 is used with surfactant lb, sparging with air and heating does not destabilize the latex.^{22,23} It was postulated in the case of 2b and 3b that no transfer of protons would occur from the initiator to the surfactant, since the imidazoline fragments are more basic than the tertiary amine or phenylamidine head groups of 2a and 3a, thus the surfactant would remain switchable. The results in Table 3 show that the particle size does decrease when this initiator is used and the polymerization is carried out at 50° C. (Table 3, entries 1-3 versus Table 2, entry 1).

The second strategy involved adding CTAB as a co-surfactant to impart extra stability to the emulsion and subsequent latex. This strategy also produced smaller particles, as is shown in Table 3, entries 4 and 5. In both of the above cases, a very small amount of VA-044 or CTAB was used to ensure that the synthesized latex was not too stable.

The third strategy involved pressurizing the reaction vessel to ensure that more CO₂ was dissolved in the emulsion in order to increase the amount of surfactant in the charged form. When the polymerization reaction was carried out at a higher pressure in a stainless steel Parr vessel, the particle size decreased compared to the same reaction at atmospheric pressure (Table 3, entry 6 versus Table 2, entry 1). This is an indication that more bicarbonate surfactant is present in the aqueous phase at higher CO₂ pressures. The particle size is not as small as it is in the case where 1b.HCl was used, indicating that some of the surfactant remains in the uncharged form, likely dissolved in the monomer phase where it is not as easily converted to a bicarbonate salt.

TABLE 3
Variation in particle size and ζ-potential of latexes synthesized by
changing the conditions to promote the formation of <200 nm particles.^{a}

| | | | | Particle | | |
|---|---|---|---|---|---|---|
| | | Mol | | Size^{e} | Zeta | |
| | Change in | % 2a | Mol % | (nm) | Potential^{e} | Conversion |
| | procedure | Added | Initiator^{b} | (PdI) | (mV) | (%) |
| 1 | Initiator is | 1.0 | 0.25 | 167 ± 2 | 41 ± 2 | 96 |
| | VA-044 | | | | | |
| 2 | Initiator is | 1.0 | 0.10 | 154 ± 2 | 39 ± 2 | — |
| | VA-044 | | | | | |
| 3 | Initiator is | 1.0 | 0.05 | 161 ± 2 | 34 ± 2 | 92 |
| | VA-044 | | | | | |
| 4 | CTAB | 1.0 | 0.25 | 78 ± 1 | 43 ± 4 | 99 |
| | was | | | | | |
| | added^{c} | | | | | |
| 5 | CTAB | 0.25 | 0.25 | 126 ± 1 | 39 ± 2 | 87 |
| | was | | | | | |
| | added^{c} | | | | | |
| 6 | Increased | 1.0 | 0.25 | 174 ± 1 | 44 ± 1 | 88 |
| | CO₂ | | | | | |
| | pressure^{d} | | | | | |

^{a}Polymerization was carried out at 65° C. for 2 h, at 13.5 wt % MMA;
^{b}Initiator is VA-061 unless otherwise indicated;
^{c}6.3 mol % (with respect to 2a) was used;
^{d}Pressure was ~5 atm;
^{e}Ranges indicate the standard deviation in the particle size and ζ-potential measurements using the Zetasizer ZS.

Attempts to produce polymer latexes with 24 wt % polymer using of 2a and the initiator VA-061 resulted in high amounts of coagulum, high viscosities and significant aggregation. The strategy employed above to make smaller, more stable particles, by using VA-044 as an initiator and lower reaction temperatures, was successfully employed to make 24 wt % latexes. As an example, 1.5 mol % 2b and 0.05 mol % VA-044 were used at 50° C. to make a latex with 193±3 nm particles (PdI=0.07) with a ζ-potential of 36±1 mV. No coagulum or aggregates formed during the synthesis and the latex could be successfully destabilized using only air at 65° C.

Long term stability of the polymer latex synthesized using the conditions in Table 1, entry 11 was assessed by exposing one half of the latex to air and storing it in a loosely capped vial, and storing the other half under an atmosphere of CO₂ in a capped vial with parafilm.

Initial particle size and ζ-potentials were compared to those taken after 3 weeks for both samples and the data is summarized in Table 4. The particle size of the sample exposed to air dramatically increases and the zeta potential decreases, and no changes are observed in the case of the latex sealed under CO₂. From this data, we conclude that the latexes remain stable when they are maintained under an atmosphere of CO₂.

TABLE 4
Assessment of the long term stability of a latex synthesized according to
the conditions in Table 1, entry 11 (13.5 wt % MMA, 0.25 mol % 3b,
0.25 mol % VA-061).

| | Particle Size | | |
|---|---|---|---|
| | Zetasizer | Mastersizer | ζ-Potential |
| | (nm) (PdI) | (nm) | (mV) |
| Initial | 381 ± 5 (0.10) | 278 | 32 ± 1 |
| After 3 weeks (stored under | 419 ± 3 (0.10) | 261 | 35 ± 1 |
| CO₂) | | | |
| After 3 weeks (exposed to | — | 4500 | 8.5 ± 0.6 |
| air and capped) | | | |

^{a}Measurements were taken at room temperature.

Destabilization.

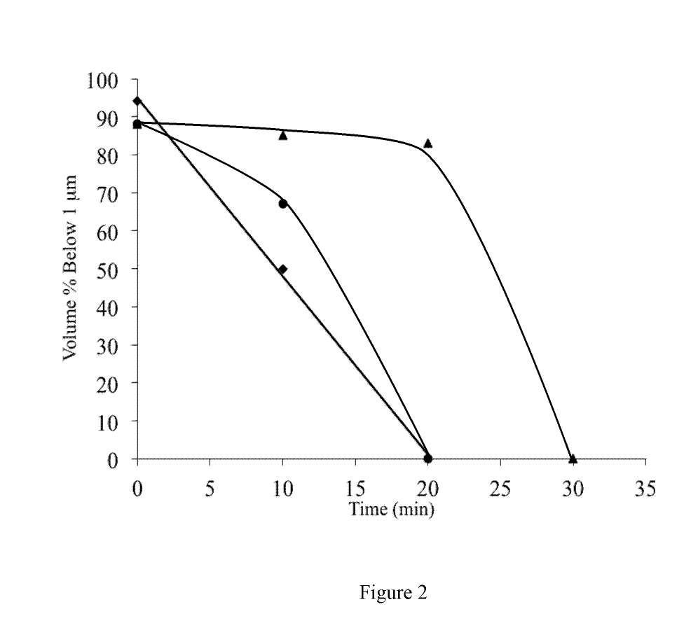

Destabilization of the polymer latexes was achieved by sparging the latexes with air or Ar to remove the CO₂. During PMMA latex destabilization using 1b, a distinct population of particles at ˜6 μm formed, creating a bimodal particle size distribution (the other peak in the distribution being the original particle size).²² This bimodal distribution was also observed during the destabilization of latexes synthesized using 2b and 3b. One way to determine the efficiency and rate of the destabilization process is to calculate the volume percentage of each of the particle populations over time. This type of analysis was carried out for the destabilization of latexes formed with 3b using the conditions of Table 1, entry 11 (FIG. 2). After sparging the latex with air at 40 or 65° C., there were no initial nanometer-sized particles remaining after 20 min. Furthermore, it was found that the destabilization could be carried out to completion after 30 min at room temperature by simply sparging the latex with air with no additional heat supplied. Using surfactant ib, latexes synthesized under similar conditions required 4 h of sparging with air and heating (65° C.) to be fully destabilized.²²

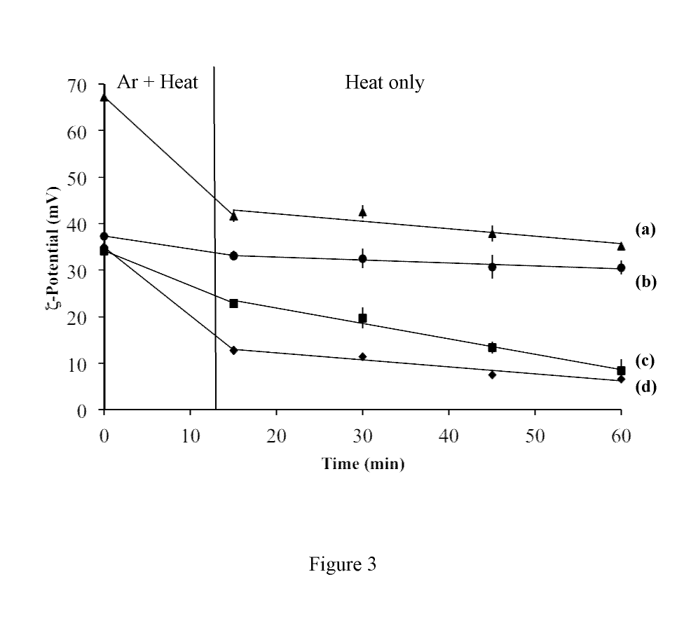

In order to determine whether latex destabilization was occurring due to the decreased surface charge on the polymer particles upon CO₂ removal, the ζ-potential was monitored over time during Ar and heat (65° C.) treatment. FIG. 3 shows that the ζ-potential decreases more rapidly when sparging with inert gas is combined with heating; but that simply heating the latex also decreases the ζ-potential, albeit at a slower rate. It has been shown previously for PMMA latexes synthesized using lb that the ζ-potential beyond which destabilization occurs is ˜25 mV.²² FIG. 3A, C and D show that the surface charge of the PMMA particles decreases below the threshold within the first 20 min in the cases where surfactants 2b and 3b are used, in contrast to the latex produced using 1b, whose particles surface charge did not decrease below 25 mV even after 60 min of Ar and heat treatment. Destabilization (appearance of flocs and an increase in latex viscosity) was observed visually in the latexes synthesized using 2b and 3b after the first 15 min of destabilization. To ensure that it was not simply a higher starting ζ-potential causing the greater stability of the latex synthesized using 1b (FIG. 3A) another latex was synthesized using less 1b and VA-061 (0.07 mol % each) to ensure that the starting ζ-potential matched those in FIGS. 3C and D. In this case (FIG. 3B), the initial surface charge was 37 mV and it was found that Ar and heat treatment caused little change in the ζ-potential. Thus in both cases, latexes synthesized using 2b and 3b destabilized much more rapidly than those synthesized using 1b. This shows that surfactant lb requires more harsh conditions than 2b and 3b to remove CO₂.

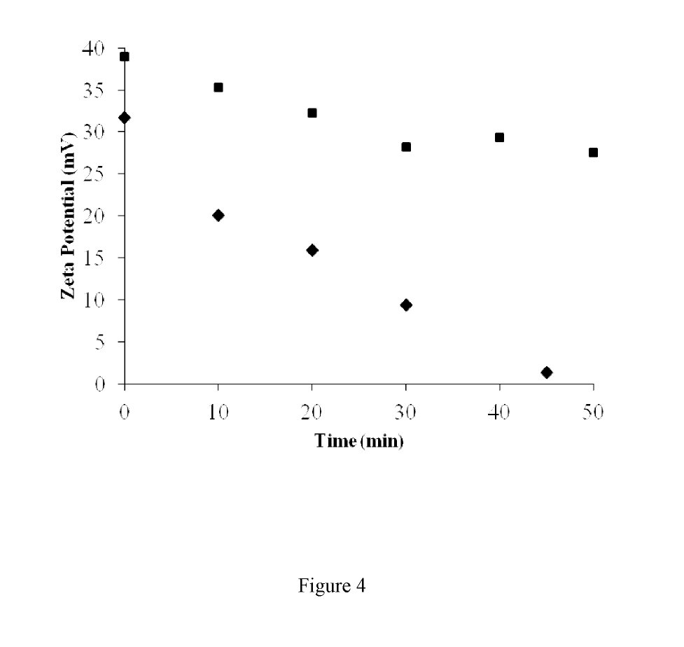

In the case where VA-044 was used as an initiator to promote the formation of small particles, latex destabilization occurred only when a very small amount of initiator was used (0.05 mol % with respect to monomer). This indicates that the charged initiator end groups contribute greatly to latex stability, and that their concentration must be minimized in order to ensure that the latex can be destabilized. When CTAB was used as a co-surfactant, the same phenomenon was observed; latex destabilization was possible as long as the concentration of CTAB was kept sufficiently low. Increased sample viscosity was observed after the first 30 min of treatment when 0.016 mol % was used. This corresponds to a decrease ζ-potential from 40 mV to 27 mV (FIG. 4), where the ζ-potential levels off (which is expected since CTAB will remain in its charged form). The low concentration of CTAB used in this experiment ensures that this leveling off will happen at or below the “threshold of destabilization”, which is ˜25 mV. In contrast, destabilization of the latex synthesized with 0.063 mol % CTAB did not occur in the first 60 min of treatment.

In summary, this Example demonstrates the successful use of a tertiary amine-based switchable surfactant, with atmospheric pressure CO₂ as the ionizing trigger, in the emulsion polymerization of MMA to produce stable latex particles. These latexes were stable when maintained under an atmosphere of CO₂. Upon CO₂ removal using a non-acidic gas, heat or a combination of both, the surfactant readily became uncharged (i.e., switched off) and the latexes were destabilized. These tertiary amine-based surfactants offer an advantage over the previously developed surfactants due to their ability to easily and rapidly revert to the uncharged forms. Both the tertiary amine-based surfactant aryl acetamidine-based surfactant have similar basicities and yield similar results when used in emulsion polymerization, however, the long chain tertiary amine offers a clear advantage due to its lower cost and commercial availability.

### REFERENCES

(1) Schramm, L. L. Emulsions, foams, and suspensions: fundamentals and applications; Wiley-VCH: Weinheim, 2005.
(2) Sakai, H.; Matsumura, A.; Yokoyama, S.; Saji, T.; Abe, M. J. Phys. Chem. B 1999, 103, 10737-10740.
(3) Minkenberg, C. B.; Florusse, R. E.; Koper, G. J. M.; van Esch, J. H. J. Am. Chem. Soc. 2009, 131, 11274-11275.
(4) Sakai, H.; Abe, M. Control of Molecular Aggregate Formation and Solubilization using Electro- and Photoresponsive Surfactant Mixtures. In Mixed Surfactant Systems; Abe, M., Scamehorn, J. F., Eds.; Surfactant Science Series; Marcel Dekker: New York, 2005; Vol. 124, pp 507-543.
(5) Schmittel, M.; Lal, M.; Graf, K.; Jeschke, G.; Suske, I.; Salbeck, J. Chem. Commun. 2005, 5650-5652.
(6) Saji, T.; Hoshino, K.; Aoyagui, S. J. Am. Chem. Soc. 1985, 107, 6865-6868.
(7) Anton, P.; Koeberle, P.; Laschewsky, A. Progress in Colloid & Polymer Science 1992, 89, 56-59.
(8) Datwani, S. S.; Truskett, V. N.; Rosslee, C. A.; Abbott, N. L.; Stebe, K. J. Langmuir 2003, 19, 8292-8301.
(9) Aydogan, N.; Abbott, N. L. Langmuir 2001, 17, 5703-5706.
(10) Cheng, Z.; Ren, B.; Gao, M.; Liu, X.; Tong, Z. Macromolecules 2007, 40, 7638-7643.
(11) Tsuchiya K.; Orihara Y.; Kondo Y.; Yoshino N.; Ohkubo T.; Sakai H.; Abe M. J. Am. Chem. Soc. 2004, 126, 12282-12283.
(12) Ghosh, S.; Irvin, K.; Thayumanavan, S. Langmuir 2007, 23, 7916-7919.
(13) Mirarefi, P.; Lee, C. T. Jr. Biochimica et Biophysica Acta, Proteins and Proteomics, 2010, 1804, 106-114.
(14) Sakai, H.; Matsumura, A.; Yokoyama, S.; Saji, T.; Abe, M. J. Phys. Chem. B 1999, 103, 10737-10740.
(15) Dexter, A. F.; Malcolm, A. S.; Middelberg, A. P. J. Nat Mater 2006, 5, 502-506.
(16) Dexter, A. F.; Middelberg, A. P. J. Ind Eng Chem Res 2008, 47, 6391-6398.
(17) Liu, Y.; Jessop, P. G.; Cunningham, M.; Eckert, C. A.; Liotta, C. L. Science 2006, 313, 958-960.
(18) L. M. Scott, M. Sc. Thesis, Queen's University, 2009
(19) Y. Qin, H. Yang, J.Ji, S. Yao, Y. Kong and Y. Wang, Tenside Surf Det., 2009, 46, 294-296.
(20) Harjani, J. R.; Liang, C.; Jessop, P. G. J. Org. Chem. 2011, 76, 1683-1691.
(21) Liang, C.; “Cationic and Anionic Carbon Dioxide Responsive Switchable Surfactants.” M. Sc. Thesis, Queen's University, Kingston, Ontario, 2010
(22) Fowler, C. I.; Muchemu, C. M.; Miller, R. E.; Phan, L.; O'Neill, C.; Jessop, P. G.; Cunningham, M. F. Macromolecules 2011, 44, 2501-2509.
(23) Mihara, M.; Jessop, P.; Cunningham, M. Macromolecules 2011.
(24) Blackley, D. C. High Polymer Latices: Their Science and Technology; Palmerton Publishing Co. Inc.: New York, 1966.
(25) Emulsion Polymerization and Emulsion Polymers; El-Aasser, M., Lovell, P., Eds.; John Wiley & Sons, Inc.: Chichester, N.Y., 1997.
(26) Gilbert, R. G. Emulsion Polymerization: A Mechanistic Approach; Academic Press: London, 1995.
(27) Hall Jr, H. J. Am. Chem. Soc. 1957, 79, 5441-5444.
(28) Cook, M. J.; Katritzky, A. R.; Nadji, S. J. Chem. Soc., Perkin Trans. 2 1976, 211-214.
(29) Blackley, D. C. Polymer Latices: Science and Technology; Chapman & Hall: London, 1997.
(30) Tanrisever, T.; Okay, O.; Soenmezo\check{g}lu, I. C. J Appl Polym Sci 1996, 61, 485-493.
(31) Arthur, T, Harjani, J., Jessop, P. G., and Hodson, P. V., Green Chem., 2012, DOI: 10.1039/CIGC15620A.
(32) Schramm, L. L., Ed. Foams: Fundamentals and Applications in the Oil Industry; American Chemical Society: Washington, D.C., 1994.
(33) Borchardt, J. K. In Kirk-Othmer Encyclopedia of Chemical Technology; 4th ed.; Kroschwitz, J. I., Howe-Grant, M., Eds.; Wiley: New York, 1996; Vol. 18, p 405.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A composition comprising:
(a) water or an aqueous solution;
(b) a switchable surfactant compound that is a tertiary amine salt comprising a hydrophobic portion, wherein said tertiary amine salt reversibly converts to a non-salt form following contact with vacuum, heat and/or flushing gas, wherein said flushing gas is a nonreactive gas that contains insufficient CO₂, CS₂, or COS to sustain the switchable surfactant compound in its salt form;
(c) a water immiscible liquid that is in a stable emulsion with said water or aqueous solution and forms an unstable emulsion or other two-phase mixture with said water or aqueous solution when the switchable surfactant compound is converted to the non-salt form, or a water insoluble solid that is in a stable suspension with said water or aqueous solution and forms an unstable suspension or other two-phase mixture with said water or aqueous solution when the switchable surfactant compound is converted to the non-salt form; and
(d) an ionizing trigger gas that comprises CO₂, CS₂, COS, or a mixture thereof, at a pressure and an amount sufficient to convert all or a substantial portion of the amine to said salt, wherein the total pressure of the ionizing trigger gas is approximately ambient pressure.

2. The composition of claim 1, wherein the non-salt form of the switchable surfactant compound is a compound of Formula I:
R¹R²NR³
where
at least one of R¹, R², and R³ comprises a hydrophobic moiety that is selected from the group consisting of higher aliphatic moiety, higher siloxyl moiety, higher aliphatic/siloxyl moiety, aliphatic/aryl moiety, siloxyl/aryl moiety, and aliphatic/siloxyl/aryl moiety; and
the rest of R¹, R², and R³ are selected from the group consisting of a substituted or unsubstituted C₁ to C₄ alkyl group, (SiO)₁ to (SiO)₂, and Cₙ(SiO)ₘ where n is a number from 0 to 4 and m is a number from 0 to 2 and n+m≦4;
where the higher aliphatic and/or siloxyl moiety is a hydrocarbon and/or siloxyl moiety having a chain length of linked atoms corresponding to that of C₈ to C₂₅, which may be substituted or unsubstituted, and may optionally contain one or more SiO unit, one or more aryl or heteroaryl groups, one or more ether linkages, one or more ester linkages or combinations of two or more of these, and wherein the hydrophobic moiety is not substituted with an aromatic group or an electronegative atom on the carbon alpha to the amine nitrogen or a fluorine atom on the carbon beta to the amine nitrogen and wherein an aryl or heteroaryl group is not directly attached to the amine nitrogen.

3. The composition of claim 2, wherein the hydrophobic moiety is a higher aliphatic moiety that is a substituted or unsubstituted C₅ to C₂₅ aliphatic or a substituted or unsubstituted C₈ to C₂₅ aliphatic or a substituted or unsubstituted C₁₂ to C₂₅ aliphatic, such as an octyl, nonyl, decyl, undecyl, dodecyl, tridecyl, tetradecyl, pentadecyl or eicosyl group, and the rest of R¹, R², and R³ are selected from the group consisting of a substituted and unsubstituted C₁ to C₄ alkyl groups.

4. The composition of claim 3, wherein the ionizing trigger gas is CO₂.

5. The composition of claim 4, wherein the non-salt form of the switchable surfactant compound is dimethyloctylamine or dimethyldodecylamine.

6. A method for reversibly converting a tertiary amine compound of Formula I to a surfactant,
R¹R²NR³
where
at least one of R¹, R², and R³ hydrophobic moiety is selected from the group consisting of higher aliphatic moiety, higher siloxyl moiety, higher aliphatic/siloxyl moiety, aliphatic/aryl moiety, siloxyl/aryl moiety, and aliphatic/siloxyl/aryl moiety; and
the rest of R¹, R², and R³ are selected from the group consisting of a substituted or unsubstituted C₁ to C₄ alkyl group, (SiO)₁ to (SiO)₂, and Cₙ(SiO)ₘ where n is a number from 0 to 4 and m is a number from 0 to 2 and n+m≦4;
where the higher aliphatic and/or siloxyl moiety is a hydrocarbon and/or siloxyl moiety having a chain length of linked atoms corresponding to that of C₈ to C₂₅, which may be substituted or unsubstituted, and may optionally contain one or more SiO unit, one or more aryl or heteroaryl groups, one or more ether linkages, one or more ester linkages or combinations of two or more of these, and wherein the hydrophobic moiety is not substituted with an aromatic group or an electronegative atom on the carbon alpha to the amine nitrogen or a fluorine atom on the carbon beta to the amine nitrogen and wherein an aryl or heteroaryl group is not directly attached to the amine nitrogen,
said method comprising the step treating the tertiary amine compound with an ionizing trigger gas that comprises CO₂, CS₂, COS, or a mixture thereof, at a pressure and an amount sufficient to convert all or a substantial portion of the amine to said salt, wherein the total pressure of the ionizing trigger gas is approximately ambient pressure.

7.-9. (canceled)

10. The method of claim 6, wherein the hydrophobic moiety is a higher aliphatic moiety is a substituted or unsubstituted C₅ to C₂₅ aliphatic or a substituted or unsubstituted C₈ to C₂₅ aliphatic or a substituted or unsubstituted C₁₂ to C₂₅ aliphatic, such as an octyl, nonyl, decyl, undecyl, dodecyl, tridecyl, tetradecyl, pentadecyl or eicosyl group, and the rest of R¹, R², and R³ are selected from the group consisting of a substituted and unsubstituted C₁ to C₄ alkyl groups.

11. The method of claim 10, wherein the tertiary amine compound is dimethyloctylamine or dimethyldodecylamine.

12. A switchable surfactant system comprising
(a) water or an aqueous solution;
(b) a switchable surfactant compound that is
in its surfactant form, wherein the surfactant form is a tertiary amine salt comprising a hydrophobic portion, wherein said tertiary amine salt reversibly converts to a non-salt form following contact with vacuum, heat and/or flushing gas, wherein said flushing gas is a nonreactive gas that contains insufficient CO₂, CS₂, or COS to sustain the switchable surfactant compound in its salt form;
in its non-surfactant form, wherein the non-surfactant form is a tertiary amine comprising a hydrophobic portion, wherein said tertiary amine reversibly converts to a salt form following contact with an ionizing trigger gas that comprises CO₂, CS₂, COS, or a mixture thereof, at a pressure and an amount sufficient to convert all or a substantial portion of the amine to said salt, wherein the total pressure of the ionizing trigger gas is approximately ambient pressure; or
in a mixture of its surfactant form and its non-surfactant form; and
(c) means for introducing
(i) the vacuum, heat and/or a flushing gas;
(ii) the ionizing trigger gas; or
(iii) CO both (i) and (ii),

13. The system of claim 12, wherein the switchable surfactant in its non-surfactant form, is a tertiary amine compound of Formula I,
R¹R²NR³
where
at least one of R¹, R², and R³ is a hydrophobic moiety selected from the group consisting of higher aliphatic moiety, higher siloxyl moiety, higher aliphatic/siloxyl moiety, aliphatic/aryl moiety, siloxyl/aryl moiety, and aliphatic/siloxyl/aryl moiety; and
the rest of R¹, R², and R³ are selected from the group consisting of a substituted or unsubstituted C₁ to C₄ alkyl group, (SiO)₁ to (SiO)₂, and Cₙ(SiO)ₘ where n is a number from 0 to 4 and m is a number from 0 to 2 and n+m≦4;
where the higher aliphatic and/or siloxyl moiety is a hydrocarbon and/or siloxyl moiety having a chain length of linked atoms corresponding to that of C₅ to C₂₅, which may be substituted or unsubstituted, and may optionally contain one or more SiO unit, one or more aryl or heteroaryl groups, one or more ether linkages, one or more ester linkages or combinations of two or more of these, and wherein the hydrophobic moiety is not substituted with an aromatic group or an electronegative atom on the carbon alpha to the amine nitrogen or a fluorine atom on the carbon beta to the amine nitrogen and wherein an aryl or heteroaryl group is not directly attached to the amine nitrogen.

14. The system of claim 13, wherein the hydrophobic moiety is a higher aliphatic moiety is a substituted or unsubstituted C₅ to C₂₅ aliphatic or a substituted or unsubstituted C₈ to C₂₅ aliphatic or a substituted or unsubstituted C₁₂ to C₂₅ aliphatic, such as an octyl, nonyl, decyl, undecyl, dodecyl, tridecyl, tetradecyl, pentadecyl or eicosyl group, and the rest of R¹, R², and R³ are selected from the group consisting of a substituted and unsubstituted C₁ to C₄ alkyl groups.

15. The system of claim 14, wherein the tertiary amine compound is dimethyloctylamine or dimethyldodecylamine.

16. The composition of claim 1, wherein the ionizing trigger gas is CO₂.

17. The composition of claim 2, wherein the ionizing trigger gas is CO₂.

18. The method of claim 6, wherein the ionizing trigger gas is CO₂.

19. The method of claim 18, additionally comprising the step of mixing a water immiscible liquid with said water or aqueous solution before, during or after treating the tertiary amine compound with CO₂, to form a stable emulsion of the water immiscible liquid with said water or aqueous solution.

20. The method of claim 18, additionally comprising the step of mixing a water insoluble solid with said water or aqueous solution before, during or after treating the tertiary amine compound with CO₂, to form a stable suspension of said water insoluble solid with said water or aqueous solution.

21. The method of claim 18, additionally comprising:
mixing the tertiary amine compound with a monomer or a mixture of monomers before, after or during the step of treating with CO₂;
adding an initiator compound; and
maintaining the resulting mixture under a CO₂-containing atmosphere to facilitate emulsion polymerization of the monomer or mixture of monomers.

22. The system of claim 12, wherein the ionizing trigger gas is CO₂.

23. The system of claim 13, wherein the ionizing trigger gas is CO₂.
